(19) United States
(12) Patent Application Publication
(10) Pub. No.: US 2026/0213347 A1
(43) Pub. Date: Jul. 23, 2026

(54) METHOD FOR MANUFACTURING ENERGY STORAGE MODULE

(71) Applicant: KABUSHIKI KAISHA TOYOTA JIDOSHOKKI, Kariya-shi, Aichi (JP)

(72) Inventors: Mikiya KURITA, Aichi (JP); Yukari KAJIYAMA, Aichi (JP); Takahiro SUGIOKA, Aichi (JP); Fumihiko ISHIGURO, Aichi (JP); Takayuki HIROSE, Aichi (JP); Hayato KUBO, Aichi (JP); Takahiro YABUUCHI, Aichi (JP)

(73) Assignee: KABUSHIKI KAISHA TOYOTA JIDOSHOKKI, Kariya-shi, Aichi (JP)

(21) Appl. No.: 19/138,463

(22) PCT Filed: Dec. 6, 2023
(86) PCT No.: PCT/JP2023/043701

§ 371 Date: Jun. 12, 2025

(30) Foreign Application Priority Data
Dec. 28, 2022 (JP) 2022-211651

(51) Int. Cl. H01M 50/46; H01M 4/02; H01M 50/184; H01M 50/193; H01M 50/474; H01M 50/486

(52) U.S. Cl. CPC H01M 50/46; H01M 50/184; H01M 50/193; H01M 50/474; H01M 50/486; H01M 2004/029

(57) ABSTRACT

A method for manufacturing a power storage module includes: a restraining step of disposing a pair of restraining plates at both ends of a stack in a first direction and restraining the stack in the first direction by the pair of restraining plates; and a cutting step of cutting a part of the stack by a rotary blade with setting the first direction to an up-down direction in a state where the stack is restrained by the pair of restraining plates to form a cut surface after the restraining step. In the restraining step, the stack is restrained such that an outer frame region is exposed from the pair of restraining plates, and in the cutting step, an end portion of the outer frame region is cut to form the cut surface.

### TECHNICAL FIELD

The present disclosure relates to a method for manufacturing a power storage module.

### BACKGROUND ART

Patent Literature 1 describes a method for cutting a fiber aggregate. In this method, a sheet-shaped fiber aggregate as an object to be cut is supported from below by a support portion having a pair of support planes provided at a predetermined interval. In addition, the surface of the fiber aggregate is pressed from above by a surface pressing portion positioned above the support portion and having a pair of surface pressing surfaces provided at substantially the same interval as the predetermined interval. Then, the fiber aggregate is cut by moving a gap formed by the predetermined interval while rotating a rotary blade with the fiber aggregate being pressed across the gap by the surface pressing portion.

### CITATION LIST

### Patent Literature

Patent Literature 1: International Publication WO 2016/170674

### SUMMARY OF INVENTION

### Technical Problem

Incidentally, in manufacturing of a power storage module, in order to uniformly weld an end surface of a resin stack formed by stacking thin resin members, there is a demand for cutting an end portion of the resin stack to form a flat cut surface (end surface). For this reason, in the above technical field, it is required to suppress generation of burrs at the time of cutting the resin stack.

An object of the present disclosure is to provide a method for manufacturing a power storage module capable of suppressing generation of burrs at the time of cutting a resin stack.

### Solution to Problem

A method for manufacturing a power storage module according to the present disclosure is a method for manufacturing a power storage module, the power storage module including an electrode stack configured by stacking a plurality of electrodes each including a current collector provided with an active material layer along a first direction, and a sealing body made of a resin, the sealing body provided on the electrode stack so as to surround the electrode stack and sealing an internal space between the current collectors adjacent to each other, the method including: a stacking step of stacking the electrodes and a sealing member made of a resin along the first direction to form a stack including the electrode stack and a resin stack containing a plurality of the sealing members; a restraining step of disposing a pair of restraining plates at both ends of the stack in the first direction and restraining the stack in the first direction by the pair of restraining plates after the stacking step; and a cutting step of cutting a part of the stack by a rotary blade with setting the first direction to an up-down direction in a state where the stack is restrained by the pair of restraining plates to form a cut surface after the restraining step, in which the sealing member is a frame-shaped member provided on a peripheral edge portion of the electrode, the resin stack includes an inner frame region overlapping the electrode stack and an outer frame region protruding from the electrode stack along a second direction intersecting the first direction when viewed in the first direction, in the restraining step, the stack is restrained such that the outer frame region is exposed from the pair of restraining plates while the inner frame region is gripped along the first direction by the pair of restraining plates, and in the cutting step, the cut surface is formed by cutting an end portion of the outer frame region in the second direction while moving the rotary blade along a third direction intersecting the first direction and the second direction.

In this manufacturing method, first, a stack including a resin stack is formed. The resin stack includes a plurality of sealing members made of a resin provided on a peripheral edge portion of the current collector of the electrode. The resin stack includes an inner frame region overlapping the electrode stack and an outer frame region protruding from the electrode stack when viewed in the first direction (stack direction). Thereafter, in a state where the stack is restrained by a pair of restraining plates, a part of the stack is cut by a rotary blade. More specifically, in a state where the inner frame region of the resin stack is gripped by the pair of restraining plates, an end portion of the outer frame region of the resin stack is cut by the rotary blade. That is, in a state where the outer frame region of the resin stack is cantilevered by gripping the inner frame region of the resin stack by the pair of restraining plates, the resin stack can be cut. As described above, since the inner frame region of the resin stack is gripped by the pair of restraining plates, positional displacement of the resin stack can be prevented at the time of cutting the resin stack. Thereby, generation of burrs at the time of cutting is suppressed.

In the method for manufacturing a power storage module according to the present disclosure, in the cutting step, a position of a rotation axis of the rotary blade in the first direction may be positioned below a center of the resin stack in the first direction, a rotation direction of the rotary blade may be directed downward, and an entry position of the rotary blade into the resin stack in the first direction may be positioned below the center of the resin stack. In this case, a downward force applied to the resin stack due to the rotation of the rotary blade with respect to a traveling direction and an upward force applied to the resin stack due to the entry of the rotary blade with respect to the traveling direction interfere with each other, and act in a direction in which forces cancel each other. Therefore, generation of burrs at the time of cutting is suppressed. In addition, since the resin stack is cut using the upper side of the rotary blade, scattering of generated chips is suppressed. Note that the rotation direction of the rotary blade being directed downward means that the rotary blade rotates from the top to the bottom on the tip side in the traveling direction of the rotary blade with respect to the rotation axis of the rotary blade.

The method for manufacturing a power storage module according to the present disclosure may include a welding step of welding the resin stack after the cutting step, in which the resin stack may include a plurality of spacers made of a resin stacked along the first direction, in the stacking step, the resin stack may be configured so as to surround the electrode stack by stacking the sealing members and the spacers while interposing the spacer having a frame shape between the sealing members, and in the welding step, the plurality of sealing members and the plurality of spacers may be welded and integrated with each other on the cut surface in a state where the stack is restrained to form a welded region on the cut surface, and the sealing body may be formed from the resin stack. In this case, since generation of burrs is suppressed at the time of cutting the resin stack as described above, the cut surface of the resin stack can be uniformly welded.

In the method for manufacturing a power storage module according to the present disclosure, in the cutting step, a position of a rotation axis of the rotary blade in the first direction may be positioned between a center of the resin stack and a lower end of the resin stack in the first direction. In this case, chips are easily directed downward.

In the method for manufacturing a power storage module according to the present disclosure, the resin stack may include: a first portion including an upper end of the resin stack in the first direction, and a second portion including a lower end of the resin stack in the first direction, the cutting step may include: a first cutting step of cutting an end portion of the outer frame region in the first portion by the rotary blade, and a second cutting step of cutting an end portion of the outer frame region in the second portion by the rotary blade, in the first cutting step, a position of a rotation axis of the rotary blade in the first direction may be positioned above a center of the resin stack in the first direction and a rotation direction of the rotary blade may be directed downward, and in the second cutting step, the position of the rotation axis of the rotary blade in the first direction may be positioned below a center of the second portion in the first direction and the rotation direction of the rotary blade may be directed upward. In this case, the occurrence of an uncut portion can be suppressed. Note that the rotation direction of the rotary blade being directed upward means that the rotary blade rotates from the bottom to the top on the tip side in the traveling direction of the rotary blade with respect to the rotation axis of the rotary blade.

In the method for manufacturing a power storage module according to the present disclosure, in the cutting step, a high frequency wave may be applied to the rotary blade. In this case, even a relatively soft material is easily cut, and burrs are hardly generated.

In the method for manufacturing a power storage module according to the present disclosure, in the cutting step, a rotation speed of the rotary blade may be set to 200 rpm or more and 500 rpm or less. As described above, when the rotation speed of the rotary blade is set to be relatively low, welding lumps are less likely to occur on the cut surface.

In the method for manufacturing a power storage module according to the present disclosure, in the welding step, the sealing member and the spacer may be welded in a state where the stack is restrained by the pair of restraining plates. In this case, in the welding step, the restraint is unnecessary by a separate member, and the number of parts is reduced.

In the method for manufacturing a power storage module according to the present disclosure, in the cutting step, a temporarily welded portion formed by partially welding the sealing member and the spacer may be formed on the cut surface. In this case, welding in the welding step is facilitated.

In the method for manufacturing a power storage module according to the present disclosure, in the cutting step, a torque applied to the rotary blade may be adjusted such that the torque increases as at least one of the rotation speed of the rotary blade and a traveling speed of the rotary blade decreases. In this case, the rotation speed of the rotary blade can be maintained constant.

The method for manufacturing a power storage module according to the present disclosure may include a temporary fixing step of temporarily fixing the sealing member and the spacer by partially welding the sealing member and the spacer on an outer side of the current collector when viewed in the first direction before the cutting step. In this case, at the time of cutting, the end portion of the resin stack is suppressed from being separated, and generation of burrs is more reliably suppressed.

In the method for manufacturing a power storage module according to the present disclosure, in the cutting step, the resin stack may be cut while applying a point load to the resin stack from above in the outer frame region. In this case, at the time of cutting, the end portion of the resin stack is suppressed from being separated, and generation of burrs is more reliably suppressed.

In the method for manufacturing a power storage module according to the present disclosure, the sealing member stacked on an outermost layer of the stack in the first direction among the plurality of sealing members may be thicker than the other sealing member among the plurality of sealing members in the first direction. In this case, the rigidity of the resin stack is improved, and generation of burrs is more reliably suppressed.

### ADVANTAGEOUS EFFECTS OF INVENTION

According to the present disclosure, it is possible to provide a method for manufacturing a power storage module capable of suppressing generation of burrs at the time of cutting a resin stack.

### BRIEF DESCRIPTION OF DRAWINGS

FIG. 1 is a schematic cross-sectional view illustrating a power storage module according to the present embodiment.

FIG. 2 is a view illustrating a step of a method for manufacturing a power storage module according to the present embodiment, and is a schematic cross-sectional view.

FIG. 3 is a view illustrating a step of the method for manufacturing a power storage module according to the present embodiment, and is a schematic cross-sectional view.

FIG. 4 is a view illustrating a step of the method for manufacturing a power storage module according to the present embodiment, and is a schematic cross-sectional view.

FIG. 5 is a view illustrating a step of the method for manufacturing a power storage module according to the present embodiment, and a schematic side view.

FIG. 6 is a view illustrating a step of the method for manufacturing a power storage module according to the present embodiment, and a schematic side view.

FIG. 7 is a schematic side view illustrating a method for manufacturing a power storage module according to a modification.

FIG. 8 is a schematic side view illustrating a method for manufacturing a power storage module according to another modification.

FIG. 9 is a schematic side view illustrating a method for manufacturing a power storage module according to another modification.

### DESCRIPTION OF EMBODIMENTS

Hereinafter, a power storage module and a method for manufacturing a power storage module according to an embodiment will be described with reference to the drawings. In the description of each of the drawings, the same or equivalent elements will be denoted by the same reference signs, and a redundant description will not be given in some cases. In addition, an orthogonal coordinate system including a first axis defining a first direction D1, a second axis defining a second direction D2, and a third axis defining a third direction D3 may be illustrated in each of the drawings.

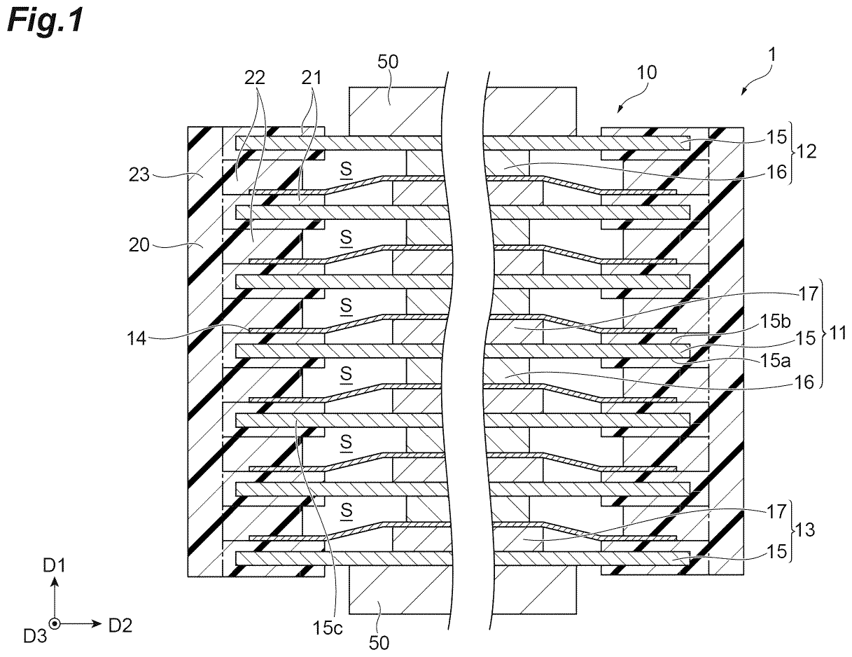

FIG. 1 is a schematic cross-sectional view illustrating the power storage module according to the present embodiment. A power storage module 1 illustrated in FIG. 1 is a power storage module used for batteries of various vehicles such as forklift trucks, hybrid vehicles, and electric vehicles, for example. The power storage module 1 is, for example, a secondary battery such as a nickel-hydrogen secondary battery or a lithium-ion secondary battery. The power storage module 1 may be an electric double-layer capacitor or an all-solid-state battery. Herein, a case where the power storage module 1 is a lithium-ion secondary battery will be illustrated.

The power storage module 1 includes an electrode stack 10 and a sealing body 20. The electrode stack 10 includes a plurality of electrodes stacked along the first direction D1. The plurality of electrodes include a plurality of bipolar electrodes 11, a positive terminal electrode 12, and a negative terminal electrode 13. A separator 14 is interposed between the electrodes adjacent to each other.

Each bipolar electrode 11 includes a current collector 15, a positive electrode active material layer 16, and a negative electrode active material layer 17. The current collector 15 has, for example, a rectangular sheet shape. The positive electrode active material layer 16 is provided on one surface 15a of the current collector 15. The negative electrode active material layer 17 is provided on the other surface 15b of the current collector 15. The plurality of bipolar electrodes 11 are stacked such that the positive electrode active material layer 16 of one bipolar electrode 11 faces the negative electrode active material layer 17 of another bipolar electrode 11. Herein, the one surface 15a of the current collector 15 is a surface facing one side in the first direction D1, and the other surface 15b of the current collector 15 is a surface facing the other side in the first direction D1.

The positive electrode active material layer 16 and the negative electrode active material layer 17 are each rectangular-shaped when viewed in the first direction D1. The negative electrode active material layer 17 has a size larger than that of the positive electrode active material layer 16 when viewed in the first direction D1. That is, in plan view viewed in the first direction D1, the entire area where the positive electrode active material layer 16 is formed is positioned within an area where the negative electrode active material layer 17 is formed.

The positive terminal electrode 12 includes the current collector 15 and the positive electrode active material layer 16 provided on the one surface 15a of the current collector 15. The positive terminal electrode 12 does not include the positive electrode active material layer 16 and the negative electrode active material layer 17 on the other surface 15b of the current collector 15. That is, an active material layer is not provided on the other surface 15b of the current collector 15 of the positive terminal electrode 12. The positive terminal electrode 12 is stacked on the bipolar electrode 11 at one end portion of the electrode stack 10 in the first direction D1. The positive terminal electrode 12 is stacked on the bipolar electrode 11 such that the positive electrode active material layer 16 thereof faces the negative electrode active material layer 17 of the bipolar electrode 11.

The negative terminal electrode 13 includes the current collector 15 and the negative electrode active material layer 17 provided on the other surface 15b of the current collector 15. The negative terminal electrode 13 does not include the positive electrode active material layer 16 and the negative electrode active material layer 17 on the one surface 15a of the current collector 15. That is, an active material layer is not provided on the one surface 15a of the current collector 15 of the negative terminal electrode 13. The negative terminal electrode 13 is stacked on the bipolar electrode 11 at an end portion of the electrode stack 10 opposite to the positive terminal electrode 12 in the first direction D1. The negative terminal electrode 13 is stacked on the bipolar electrode 11 such that the negative electrode active material layer 17 thereof faces the positive electrode active material layer 16 of the bipolar electrode 11. As described above, the electrode stack 10 is configured by stacking a plurality of electrodes including a current collector provided with an active material layer along the first direction D1.

The separator 14 is disposed between the bipolar electrodes 11 adjacent to each other, between the positive terminal electrode 12 and the bipolar electrode 11, and between the negative terminal electrode 13 and the bipolar electrode 11. The separator 14 is interposed between the positive electrode active material layer 16 and the negative electrode active material layer 17. The separator 14 is a member that causes charge carriers such as lithium ions to pass therethrough. The separator 14 separates the positive electrode active material layer 16 and the negative electrode active material layer 17, and prevents a short circuit due to contact between the electrodes adjacent to each other.

The current collector 15 is a chemically inactive electric conductor that causes a current to continuously flow through the positive electrode active material layer 16 and the negative electrode active material layer 17 during discharge or charge of the lithium-ion secondary battery. A material of the current collector 15 is, for example, a metal material, a conductive resin material, a conductive inorganic material, or other materials. Examples of the conductive resin material include a resin obtained by adding a conductive filler to a conductive polymer material or a non-conductive polymer material as necessary. The current collector 15 may include a plurality of layers. In this case, each layer of the current collector 15 may contain the above-described metal material and/or conductive resin material.

A covering layer may be formed on a surface of the current collector 15. The covering layer may be formed by, for example, a known method such as plating or spray coating. The current collector 15 may have, for example, a plate shape, a foil shape (for example, metal foil), a film shape, a mesh shape, or other shapes. Examples of the metal foil include an aluminum foil, a copper foil, a nickel foil, a titanium foil, and a stainless steel foil. The current collector 15 may be a foil formed by integrating a metal alloy foil or a plurality of metal foils. In a case where the current collector 15 has a foil shape, a thickness of the current collector 15 may be, for example, 1 μm to 200 μm. In the present embodiment, the current collector 15 is a foil in which an aluminum foil and a copper foil are integrated, or an aluminum foil.

The positive electrode active material layer 16 contains a positive electrode active material capable of occluding and releasing charge carriers such as lithium ions. Examples of the positive electrode active material include a lithium composite metal oxide having a stratified rock salt type structure, a metal oxide having a spinel structure, and a polyanionic compound. The positive electrode active material may be any material that can be used for the lithium-ion secondary battery. The positive electrode active material layer 16 may contain a plurality of positive electrode active materials. In the present embodiment, the positive electrode active material layer 16 contains olivine lithium iron phosphate (LiFePO₄) as a composite oxide.

The negative electrode active material layer 17 contains a negative electrode active material capable of occluding and releasing charge carriers such as lithium ions. The negative electrode active material may be any of a simple substance, an alloy, or a compound. Examples of the negative electrode active material include Li, carbon, and a metal compound. The negative electrode active material may be an element that can be alloyed with lithium, a compound thereof, or other materials. Examples of the carbon include natural graphite, artificial graphite, hard carbon (non-graphitizing carbon), and soft carbon (graphitizing carbon). Examples of the artificial graphite include highly oriented graphite and meso-carbon microbeads. Examples of the element that can be alloyed with lithium include silicon and tin. In the present embodiment, the negative electrode active material layer 17 contains graphite as a carbon-based material.

Each of the positive electrode active material layer 16 and the negative electrode active material layer 17 (hereinafter, also simply referred to as “active material layer” in some cases) may further contain a conductive auxiliary, a binder, an electrolyte (such as polymer matrix, ion conductive polymer, or electrolytic solution) for increase electric conductivity, a supporting electrolyte salt (lithium salt) for increasing ion conductivity, and the like, as necessary. The conductive auxiliary is added to increase the electric conductivity of each of the electrodes (the bipolar electrodes 11, the positive terminal electrode 12, and the negative terminal electrode 13). The conductive auxiliary is, for example, acetylene black, carbon black, graphite, or the like.

Examples of the binder include fluorine-containing resins such as polyvinylidene fluoride, polytetrafluoroethylene, and fluororubber, thermoplastic resins such as polypropylene and polyethylene, imide resins such as polyimide and polyamidimide, alkoxysilyl group-containing resins, acrylic resins such as acrylic acid and methacrylic acid, styrene-butadiene rubber (SBR), carboxymethyl cellulose, alginates such as sodium alginate and ammonium alginate, water-soluble cellulose ester crosslinked bodies, and starch-acrylic acid graft polymers. The binders can be used alone or in combination. For example, water, N-methyl-2 pyrrolidone (NMP), or the like is used as a solvent of the binder.

The separator 14 may be, for example, a porous sheet or a nonwoven fabric containing a polymer that absorbs and holds an electrolyte. Examples of a material of the separator 14 include polypropylene, polyethylene, polyolefin, and polyester. The separator 14 may have a single layer structure or a multilayer structure. The multilayer structure may have, for example, a ceramic layer or the like as an adhesive layer or a heat resistant layer. The separator 14 may be impregnated with an electrolyte. The electrolyte with which the separator 14 is impregnated is a liquid electrolyte (electrolytic solution) containing a nonaqueous solvent and an electrolyte salt dissolved in the nonaqueous solvent.

Known lithium salts such as LiClO₄, LiAsF₆, LiPF₆, LiBF₄, LiCF₃SO₃, LiN(FSO₂)₂, and LiN(CF₃SO₂)₂ may be used as the electrolyte salt of the electrolytic solution. In addition, a known solvent such as cyclic carbonates, cyclic esters, chain carbonates, chain esters, or ethers may be used as the nonaqueous solvent. Note that two or more of these known solvent materials may be used in combination.

The sealing body 20 is formed in a frame shape at a peripheral edge portion of the electrode stack 10 to surround the electrode stack 10 when viewed in the first direction D1. The sealing body 20 can be joined (welded) to each of the one surface 15a and the other surface 15b of the current collector 15, at a peripheral edge portion 15c of each of the current collectors 15. The sealing body 20 is provided to form internal spaces S between the current collectors 15 adjacent to each other in the first direction D1, and seal each of the internal spaces S. An electrolyte (for example, an electrolytic solution) is contained in each of the internal spaces S. The sealing body 20 can block the permeation of the electrolytic solution to the outside. In addition, the sealing body 20 can suppress intrusion of moisture, air, and the like from the outside of the electrode stack 10 into the internal spaces S.

Edge portions of the separators 14 are joined to the sealing body 20. The sealing body 20 includes an insulating material. Examples of a material of the sealing body 20 include various resin materials such as polypropylene, polyethylene, polystyrene, ABS resin, acid-modified polypropylene, acid-modified polyethylene, and acrylonitrile styrene resin.

The sealing body 20 includes a plurality of sealing members 21 made of a resin and a plurality of spacers 22 made of a resin. Each of the sealing members 21 is provided in each of the current collectors 15. Therefore, the sealing members 21 are stacked each other along the first direction D1. The sealing member 21 has a frame shape (in this case, a rectangular frame shape) when viewed in the first direction D1, and is provided on the peripheral edge portion 15c of the current collector 15. That is, the sealing member 21 is provided to extend from the one surface 15a to the other surface 15b of the corresponding current collector 15 through its end surface, and covers the peripheral edge portion 15c. The sealing member 21 can be welded to the one surface 15a and the other surface 15b of the current collector 15. The sealing member 21 includes a frame-shaped region overlapping the current collector 15 and a frame-shaped region protruding from the current collector 15 along the second direction D2 intersecting the first direction D1 when viewed in the first direction D1.

Each of the spacers 22 is disposed to be interposed between the sealing members 21 adjacent to each other in the first direction D1. As a result, the spacer 22 holds a space between the sealing members 21 adjacent to each other, that is, between the current collectors 15 adjacent to each other, and forms the internal space S together with the sealing members 21. The spacer 22 has a frame shape (in this case, a rectangular frame shape) when viewed in the first direction D1, and is disposed on the peripheral edge portion 15c of the current collector 15 when viewed in the first direction D1. Herein, an end portion of the separator 14 is sandwiched and held between the sealing member 21 and the spacer 22. The separator 14 can be welded to at least one of the sealing member 21 and the spacer 22. The spacer 22 includes a frame-shaped region overlapping the current collector 15 and a frame-shaped region protruding from the current collector 15 along the second direction D2 intersecting the first direction D1 when viewed in the first direction D1.

The sealing body 20 further includes a welded end portion 23 formed by welding and integrating end portions of the plurality of sealing members 21 and the plurality of spacers 22 opposite to the internal spaces S. The welded end portion 23 has a frame shape to surround the electrode stack 10 when viewed in the first direction D1 and forms an outer peripheral portion of the sealing body 20. Therefore, the sealing members 21 and the spacers 22 are welded to each other, and thus, the sealing body 20 has an outer side surface 20s (an outer side surface of the welded end portion 23) formed by end surfaces of the sealing members 21 opposite to the internal spaces S and end surfaces of the spacers 22 opposite to the internal spaces S.

Note that portions exposed from the sealing body 20 on the other surface 15b of the current collector 15 of the positive terminal electrode 12 and the one surface 15a of the current collector 15 of the negative terminal electrode 13 are exposed regions. The exposed regions each overlap the positive electrode active material layer 16 and the negative electrode active material layer 17 when viewed in the first direction D1. In the exposed region, a conductive member 50 functioning as a terminal for extracting a current from the power storage module 1 is disposed and electrically connected. The conductive member 50 can be used to electrically connect a plurality of power storage modules 1. In addition, the conductive member 50 can also be used as a restraining member in order to apply a restraining load to the electrode stack 10. Furthermore, a cooling flow path may be formed in the conductive member 50. The electrode stack 10 can be cooled by circulating a cooling medium through the cooling flow path formed in the conductive member 50.

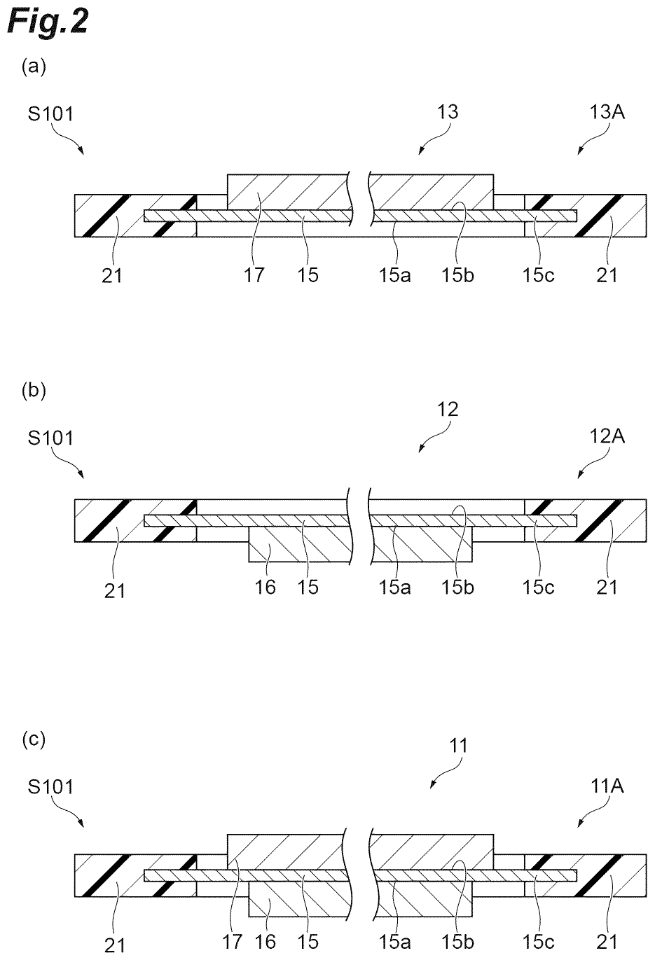

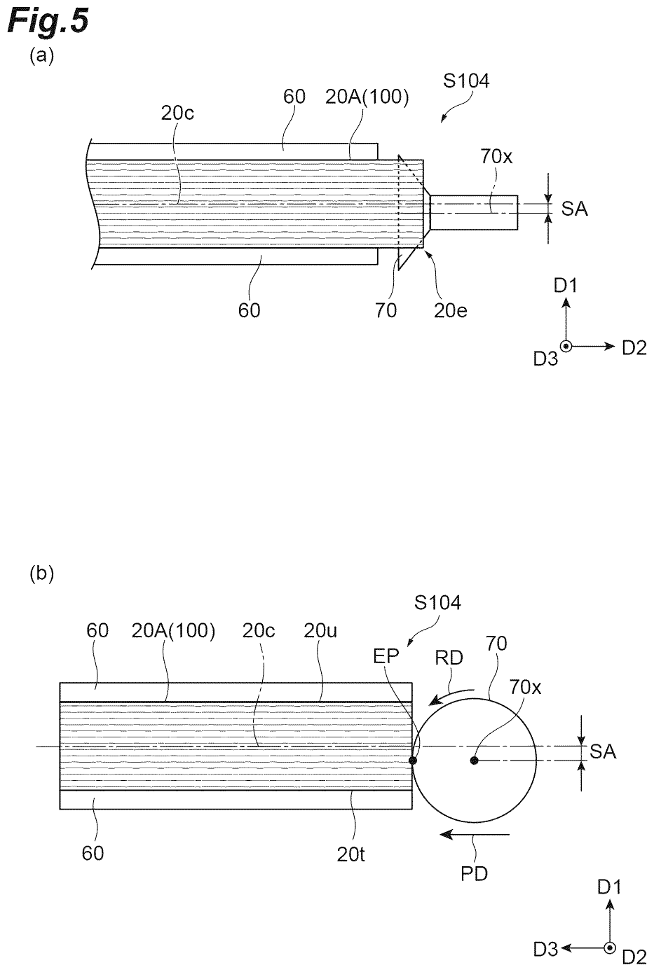

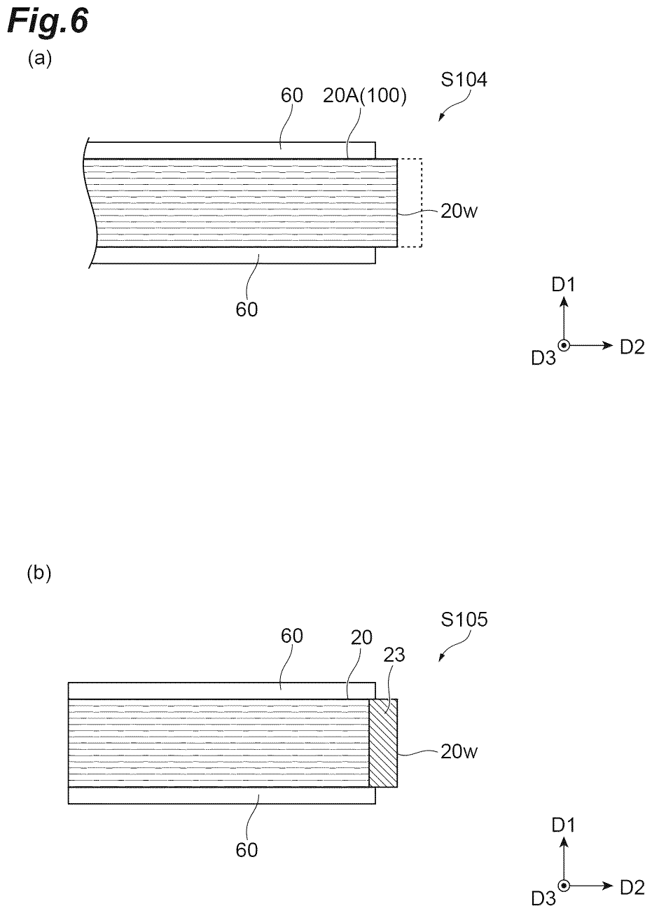

Subsequently, a power storage module manufacturing method for manufacturing the above-described power storage module 1 will be described. FIGS. 2 to 6 are views illustrating steps of the method for manufacturing a power storage module according to the present embodiment. FIGS. 2 to 4 are schematic cross-sectional views, and FIGS. 5 and 6 are schematic side views. In the manufacturing method, first, as illustrated in FIG. 2, an electrode body including an electrode and the sealing member 21 is prepared (step S101: stacking step). More specifically, the sealing member 21 is welded to the peripheral edge portion 15c of the current collector 15 of the negative terminal electrode 13 to form a third electrode body 13A. Similarly, the sealing member 21 is welded to the peripheral edge portion 15c of the current collector 15 of the positive terminal electrode 12 to form a second electrode body 12A. Furthermore, the sealing member 21 is welded to each of the peripheral edge portions 15c of the current collectors 15 of the plurality of bipolar electrodes 11 to form a plurality of first electrode bodies 11A. The first electrode body 11A, the second electrode body 12A, and the third electrode body 13A each have the current collector 15.

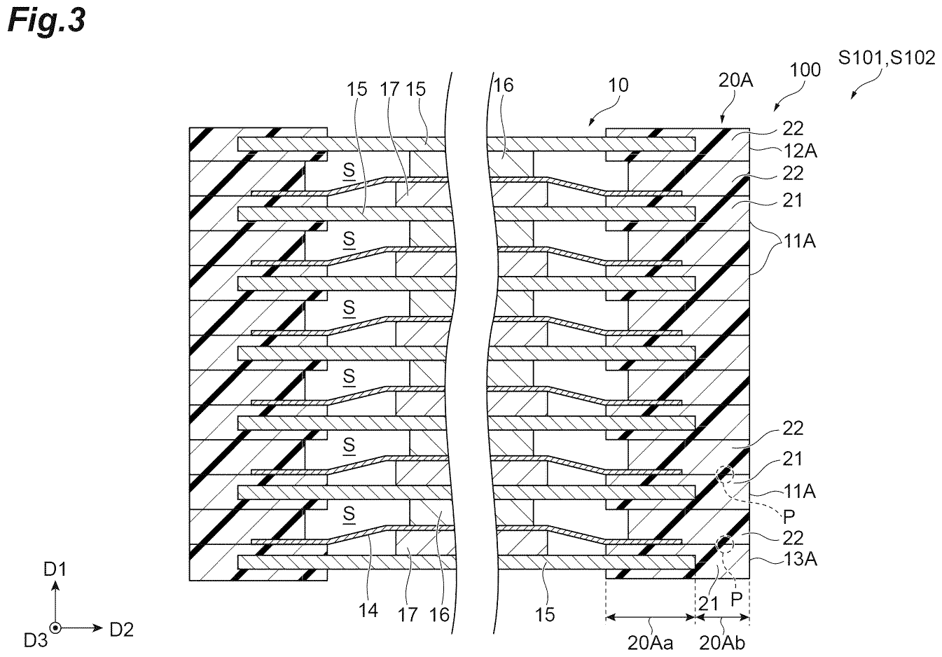

Then, as illustrated in FIG. 3, the third electrode body 13A, the plurality of first electrode bodies 11A, and the second electrode body 12A are sequentially stacked along the first direction D1 (step S101, stacking step). At this time, the spacer 22 is interposed between the sealing members 21 adjacent to each other along the first direction D1. Herein, the spacer 22 is stacked on the sealing members 21 of the first electrode body 11A and the third electrode body 13A (or the second electrode body 12A) in advance, and is temporarily fixed by welding (for example, spot-wisely) to the sealing members 21 at a predetermined position P of the outer edge portion of the sealing member 21 (step S102, temporary fixing step). The position P is a position outside the current collector 15 when viewed in the first direction D1. Thereby, the first electrode body 11A and the third electrode body 13A are each formed into a sub-assembly further including the spacer 22 and the separator 14. Then, the sub-assembly and the second electrode body 12A are sequentially stacked.

As described above, herein, the first electrode body 11A, the second electrode body 12A, and the third electrode body 13A are stacked to form a stack 100. In other words, herein, by stacking the first electrode body 11A, the second electrode body 12A, and the third electrode body 13A, the plurality of electrodes (the bipolar electrode 11, the positive terminal electrode 12, and the negative terminal electrode 13), the plurality of sealing members 21 made of a resin, and the plurality of spacers 22 are stacked along the first direction D1 to form the stack 100 (step S101, stacking step). The stack 100 includes the electrode stack 10 and a resin stack 20A. The electrode stack 10 includes the negative terminal electrode 13, the plurality of bipolar electrodes 11, and the positive terminal electrode 12 stacked along the first direction D1. That is, in the electrode stack 10, the plurality of current collectors 15 are stacked along the first direction D1.

The resin stack 20A includes the plurality of sealing members 21 and the plurality of spacers 22 alternately stacked along the first direction D1. Each sealing member 21 is frame-shaped when viewed in the first direction D1 and is provided on the peripheral edge portion 15c of the current collector 15. Each spacer 22 is frame-shaped along the sealing member 21 when viewed in the first direction D1 and is interposed between the sealing members 21 adjacent to each other. The resin stack 20A is configured to surround the electrode stack 10 by the plurality of sealing members 21 and the plurality of spacers 22.

The resin stack 20A includes an inner frame region 20Aa overlapping the electrode stack 10 (current collector 15) and an outer frame region 20Ab protruding from the electrode stack 10 (current collector 15) along the second direction D2 when viewed in the first direction D1. That is, the sealing member 21 and the spacer 22 overlap the current collector 15 in the inner frame region 20Aa and protrude from the current collector 15 in the outer frame region 20Ab when viewed in the first direction D1. The resin stack 20A includes a portion that becomes the sealing body 20 when the sealing member 21 and the spacer 22 are welded to each other to form the welded end portion 23 in the subsequent step S105. This welded end portion 23 is formed in the outer frame region 20Ab. In addition, the welded end portion 23 has an outer side surface (outer side surface 20s) extending along the first direction D1 and the third direction D3 intersecting the second direction D2.

In this step S101, as described above, the sealing member 21 and the spacer 22 are partially welded to temporarily fix the sealing member 21 and the spacer 22 at the position P outside the current collector 15 when viewed in the first direction D1 (step S102, temporary fixing step). The position P where the temporary fixing is performed is set in the outer frame region 20Ab.

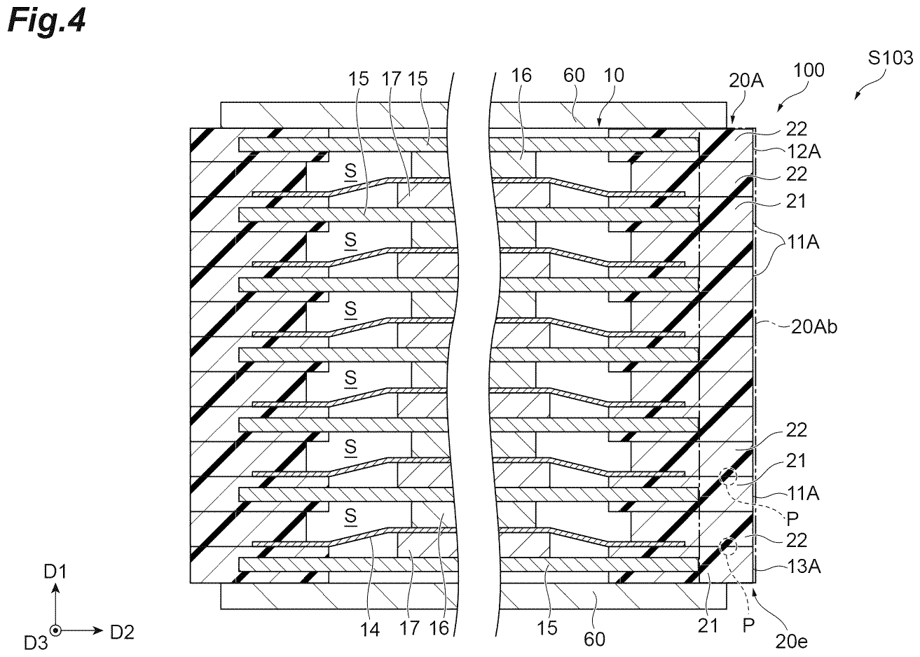

In the subsequent step, as illustrated in FIG. 4, a pair of restraining plates 60 are disposed at both ends of the stack 100 in the first direction D1, and the stack 100 is restrained in the first direction D1 by the pair of restraining plates 60 (step S103, restraining step). In step S103, while gripping the inner frame region 20Aa along the first direction D1 by the pair of restraining plates 60, the stack 100 is restrained such that the outer frame region 20Ab is exposed from the pair of restraining plates 60. In step S103, the stack 100 may be restrained by the pair of restraining plates 60 so as to extend from the center of the current collector 15 to a region (inner frame region 20Aa) where the sealing member 21 and the spacer 22 overlap when viewed in the first direction D1. In particular, the stack 100 may be restrained by the pair of restraining plates 60 so as to extend from the center of the current collector 15 to a region (a part of the inside of the outer frame region 20Ab) positioned outside the current collector 15 of the sealing member 21 and the spacer 22 when viewed in the first direction D1.

Meanwhile, in step S103, the outer frame region 20Ab is exposed from the pair of restraining plates 60 when viewed in the first direction D1. Herein, when viewed in the first direction D1, at least the end portion of the resin stack 20A, which is a part of the outer frame region Ab, may be exposed from the pair of restraining plates 60. In this case, the outer edges of the pair of restraining plates 60 are positioned outside the outer edge of the current collector 15 and positioned in the outer frame region 20Ab when viewed in the first direction D1.

Subsequently, as illustrated in FIG. 5 and (a) of FIG. 6, the resin stack 20A is cut (step S104, cutting step). More specifically, in step S104, first, the first direction D1 is set to the up-down direction by adjusting the posture of the stack 100. In the present embodiment, as an example, the first direction D1 is made to coincide with a vertical up-down direction, but the first direction D1 may be along the up-down direction and may be inclined to the vertical up-down direction to a certain extent. Then, a part (inner frame region 20Aa) of the stack 100 in the second direction D2 is held together with the pair of restraining plates 60. Thereby, the stack 100 (and the resin stack 20A) is brought into a cantilevered state. In this state, in step S104, a part of the stack 100 is cut by a rotary blade 70 to form a cut surface. More specifically, in step S104, in an end portion 20e (that is, a free end of the cantilever) outside the outer frame region 20Ab of the resin stack 20A in the second direction D2, the end portion 20e of the outer frame region 20Ab is cut while moving the rotary blade 70 along the third direction D3. Thereby, a cut surface 20w is formed.

At this time, a position of the rotation axis 70x of the rotary blade 70 in the first direction DI is positioned vertically below a center 20c of the resin stack 20A in the first direction D1. In particular, herein, the position of the rotation axis 70x of the rotary blade 70 in the first direction D1 is positioned between the center 20c of the resin stack 20A and a lower end 20t of the resin stack 20A in the first direction D1. A shift amount SA from the center 20c of the rotation axis 70x to the vertically lower side can be, for example, about 5 mm. Note that the rotary blade 70 has a disk shape herein, and the rotation axis 70x is the center of the circle.

In step S104, at the same time, a rotation direction RD of the rotary blade 70 with respect to a traveling direction PD (third direction D3) of the rotary blade 70 is directed downward. Furthermore, in step S104, the entry position EP of the rotary blade 70 into the resin stack 20A in the first direction D1 is positioned below the center 20c of the resin stack 20A. Note that the rotation direction RD of the rotary blade 70 with respect to the traveling direction PD being directed downward means that the rotary blade 70 rotates from vertically above to vertically below on the tip side in the traveling direction PD of the rotation axis 70x of the rotary blade 70 as illustrated in the drawing.

In step S104, in the above state, the rotary blade 70 is caused to enter the resin stack 20A while being rotated, and the rotary blade 70 is caused to travel over the enter width of the resin stack 20A in the third direction D3. Thereby, the end portion 20e of the outer frame region 20Ab is cut off, and the cut surface 20w is formed on the resin stack 20A. That is, the outer edges of the plurality of sealing members 21 and the plurality of spacers 22 are aligned on the cut surface 20w. On the cut surface 20w, a temporarily welded portion formed by partially welding the sealing member 21 and the spacer 22 may be formed by heat generated between the cut surface and the rotary blade 70.

Note that the rotation speed of the rotary blade 70 in step S104 can be set in a range of 200 rpm or more and 500 rpm or less, for example. In addition, the traveling speed (feeding speed) of the rotary blade 70 in step S104 can be set, for example, in a range of 20 mm/s or more and 75 mm/s. At this time, in step S104, a torque applied to the rotary blade 70 can be adjusted such that the torque increases as at least one of the rotation speed and the traveling speed of the rotary blade 70 decreases. This is because the torque required for cutting increases as the rotation speed and the traveling speed of the rotary blade 70 decrease. Furthermore, in step S104, a high frequency wave can be applied to the rotary blade 70.

In the subsequent step, as illustrated in (b) of FIG. 6, the plurality of sealing members 21 and the plurality of spacers 22 are welded and integrated with each other on the cut surface 20w of the resin stack 20A, so that the end portions of the plurality of sealing members 21 and the plurality of spacers 22 are welded to each other to form the welded end portion 23, and the sealing body 20 is formed from the resin stack 20A (step S105, welding step). Thereby, a welded region (outer side surface of the welded end portion 23) is formed on the cut surface 20w over the plurality of sealing members 21 and the plurality of spacers 22. In step S105, the sealing member 21 and the spacer 22 can be welded in a state where the stack 100 is restrained by the pair of restraining plates 60 (that is, the restraining plates 60 are not removed). At this time, a width (welding width) of the welded end portion 23 in the direction intersecting the cut surface 20w is set such that the welded end portion 23 reaches a region sandwiched by the pair of restraining plates 60 in the sealing member 21 and the spacer 22.

After the above steps, a post-step such as removal of the pair of restraining plates 60 and injection of an electrolytic solution is performed to obtain the power storage module 1 illustrated in FIG. 1.

As described above, in the method for manufacturing a power storage module according to the present embodiment, first, the stack 100 including the resin stack 20A is formed. The resin stack 20A includes the plurality of sealing members 21 made of a resin provided on the peripheral edge portion 15c of the current collector 15 of the electrode. The resin stack 20A includes the inner frame region 20Aa overlapping the electrode stack 10 and the outer frame region 20Ab protruding from the electrode stack 10 when viewed in the first direction D1 (stack direction). Thereafter, in a state where the stack 100 is restrained by the pair of restraining plates 60, a part of the stack 100 is cut by the rotary blade 70. More specifically, in a state where the inner frame region 20Aa of the resin stack 20A is gripped by the pair of restraining plates 60, the end portion 20e of the outer frame region 20Ab of the resin stack 20A is cut by the rotary blade 70. That is, in a state where the outer frame region 20Ab of the resin stack 20A is cantilevered by gripping the inner frame region 20Aa of the resin stack 20A by the pair of restraining plates 60, the resin stack 20A can be cut. As described above, since the inner frame region 20Aa of the resin stack 20A is gripped by the pair of restraining plates 60, positional displacement of the resin stack 20A can be prevented at the time of cutting the resin stack 20A. Thereby, generation of burrs at the time of cutting is suppressed.

In the method for manufacturing a power storage module according to the present embodiment, in the cutting step (step S104), the position of the rotation axis 70x of the rotary blade 70 in the first direction D1 is positioned below the center 20c of the resin stack 20A in the first direction D1, the rotation direction RD of the rotary blade 70 is directed downward, and the entry position EP of the rotary blade 70 into the resin stack 20A in the first direction DI is positioned below the center 20c of the resin stack 20A. Thereby, generation of burrs at the time of cutting is suppressed.

This point will be described with reference to (a) and (b) of FIG. 5. That is, by positioning the rotation axis 70x of the rotary blade 70 below the center 20c of the resin stack 20A, the number of resin members that escape to the lower side of the rotary blade 70 when the rotary blade 70 is caused to enter the resin stack 20A formed by stacking a plurality of resin members (sealing member 21 and spacer 22) decreases (alternatively, the amount of escape of the resin member to the lower side decreases). Thereby, cutting is performed in a state where the resin member is not moved to the lower side from the upper side. That is, it is possible to cut the resin member while reducing the amount of escape of the resin member to the lower side of the rotary blade 70. As a result, burrs generated below the resin stack 20A are reduced. This is considered to be one factor that suppresses generation of burrs at the time of cutting.

On the other hand, it is considered that by positioning the rotation axis 70x of the rotary blade 70 vertically below the center 20c of the resin stack 20A, the number of resin members that escape to the upper side of the rotary blade 70 when the rotary blade 70 is caused to enter the resin stack 20A increases (alternatively, the amount of escape of the resin member to the upper side increases). However, the resin member brought to the upper side of the rotary blade 70 is cut downward from the upper side of the resin stack 20A according to the rotation direction RD of the rotary blade 70. Therefore, the resin member brought to the upper side can be suitably cut while being pressed from the upper side to the lower side. As a result, it is considered that one factor that suppresses generation of burrs at the time of cutting is that burrs are less likely to be generated above the resin stack 20A.

Furthermore, referring to (b) of FIG. 5, by positioning the rotation axis 70x of the rotary blade 70 below the center 20c of the resin stack 20A, the entry position EP of the rotary blade 70 into the resin stack 20A is provided below the center 20c of the resin stack 20A. That is, the rotary blade 70 enters the resin stack 20A from the entry position EP below the center 20c of the resin stack 20A. Therefore, when viewed in the second direction D2, a contact point (point at which cutting is performed) between the rotary blade 70 and the resin stack 20A moves from the vertically lower side to the vertically upper side according to the traveling of the rotary blade 70. That is, the resin stack 20A is subjected to stress associated with movement of the rotary blade 70 from the vertically lower side to the vertically upper side. On the other hand, when viewed in the second direction D2, the resin stack 20A is further subjected to stress accompanying the rotation of the rotary blade 70 from the vertically upper side to the vertically lower side according to the downward rotation direction RD of the rotary blade 70. In this manner, it is considered that by positioning the entry position EP of the rotary blade 70 below the center 20c of the resin stack 20A, the stress on the resin stack 20A from the rotary blade 70 can be reduced. That is, a downward force applied to the resin stack 20A due to the rotation of the rotary blade 70 with respect to the traveling direction PD and an upward force applied to the resin stack 20A due to the entry of the rotary blade 70 with respect to the traveling direction OD interfere with each other, and act in a direction in which forces cancel each other. This is also considered to be one factor that suppresses generation of burrs at the time of cutting.

That is, in the method for manufacturing a power storage module according to the present embodiment, it is considered that generation of burrs can be suitably suppressed by both the contribution that the rotation axis 70x of the rotary blade 70 is positioned below the center 20c of the resin stack 20A and the contribution that the rotation direction RD of the rotary blade 70 with respect to the traveling direction PD is directed downward at the time of cutting in a cantilevered state.

The method for manufacturing a power storage module according to the present embodiment includes a welding step (step S105) of welding the resin stack 20A after the cutting step (step S104). The resin stack 20A includes the plurality of spacers 22 made of a resin stacked along the first direction D1. In the stacking step (step S101), the resin stack 20A is configured so as to surround the electrode stack 10 by staking the sealing members 21 and the spacers 22 while interposing the spacer 22 having a frame shaped between the sealing members 21. Then, in the welding step (step S105), the plurality of sealing members 21 and the plurality of spacers 22 are welded and integrated with each other on the cut surface 20w in a state where the stack 100 is restrained to form a welded region on the cut surface 20w, and the sealing body 20 is formed from the resin stack 20A. As a result, since generation of burrs is suppressed at the time of cutting the resin stack 20A as described above, the cut surface 20w of the resin stack 20A can be uniformly welded.

In addition, in the method for manufacturing a power storage module according to the present embodiment, in the cutting step (step S104), the position of the rotation axis 70x of the rotary blade 70 in the first direction D1 may be positioned between the center 20c of the resin stack 20A and the lower end 20t of the resin stack 20A in the first direction D1. Thereby, chips are easily directed vertically downward. In addition, in this case, for example, as compared with a case where the position of the rotation axis 70x of the rotary blade 70 is below the lower end 20t of the resin stack 20A, the size of the rotary blade 70 for allowing the rotary blade 70 to reach an upper end 20u of the resin stack 20A can be reduced.

In addition, in the method for manufacturing a power storage module according to the present embodiment, in the cutting step (step S104), a high frequency wave may be applied to the rotary blade 70. In this case, even a relatively soft material is easily cut, and burrs are hardly generated.

In addition, in the method for manufacturing a power storage module according to the present embodiment, in the cutting step (step S104), a rotation speed of the rotary blade 70 may be set to 200 rpm or more and 500 rpm or less. As described above, when the rotation speed of the rotary blade 70 is set to be relatively low, welding lumps are less likely to occur on the cut surface 20w.

In addition, in the method for manufacturing a power storage module according to the present embodiment, in the welding step (step S105), the sealing member 21 and the spacer 22 are welded in a state where the stack 100 is restrained by the pair of restraining plates 60. Therefore, in the welding step (step S105), the restraint is unnecessary by a separate member, and the number of parts is reduced.

In addition, in the method for manufacturing a power storage module according to the present embodiment, in the cutting step (step S104), a temporarily welded portion formed by partially welding the sealing member 21 and the spacer 22 may be formed on the cut surface 20w. In this case, welding in the welding step (step S105) is facilitated.

In addition, in the method for manufacturing a power storage module according to the present embodiment, in the cutting step (step S104), a torque applied to the rotary blade 70 may be adjusted such that the torque increases as at least one of the rotation speed of the rotary blade 70 and the traveling speed of the rotary blade 70 decreases. In this case, the rotation speed of the rotary blade 70 can be maintained constant.

In addition, the method for manufacturing a power storage module according to the present embodiment may include a temporary fixing step (step S102) of temporarily fixing the sealing member 21 and the spacer 22 by partially welding the sealing member 21 and the spacer 22 on an outer side of the current collector 15 when viewed in the first direction D1 before the cutting step (step S104). In this case, at the time of cutting, the end portion 20e of the resin stack 20A is suppressed from being separated, and generation of burrs is more reliably suppressed.

Furthermore, in the method for manufacturing a power storage module according to the present embodiment, in the cutting step (step S104), the resin stack 20A may be cut while applying a point load to the resin stack 20A from above in the outer frame region 20Ab. In this case, at the time of cutting, the end portion 20e of the resin stack 20A is suppressed from being separated, and generation of burrs is more reliably suppressed.

The above embodiment describes one aspect of the present invention. Therefore, the method for manufacturing a power storage module according to the present invention is not limited to the above-described embodiment, and can be modified in any way.

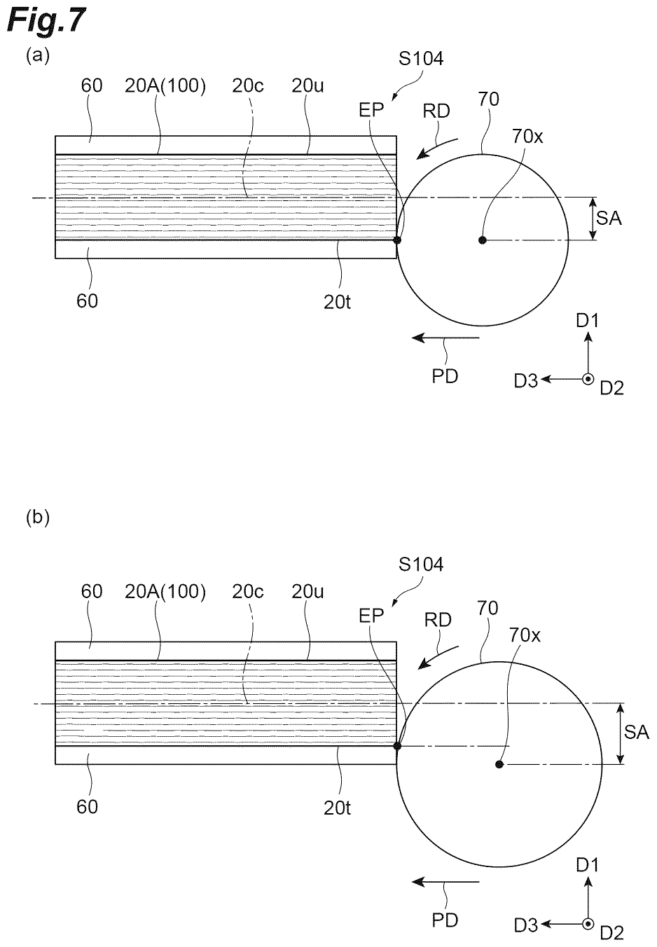

For example in the above-described embodiment, in the cutting step (step S104), the position of the rotation axis 70x of the rotary blade 70 in the first direction D1 is positioned between the center 20c of the resin stack 20A and the lower end 20t of the resin stack 20A in the first direction D1. The fact that the rotation axis 70x of the rotary blade 70 is positioned between the center 20c and the lower end 20t in the first direction D1 includes not only a case where the rotation axis 70x is positioned above the lower end 20t as illustrated in FIG. 5 but also a case where the position of the rotation axis 70x is positioned at the lower end 20t of the resin stack 20A in the first direction D1 as illustrated in (a) of FIG. 7. Alternatively, as illustrated in (b) of FIG. 7, in step S104, the position of the rotation axis 70x of the rotary blade 70 in the first direction D1 may be positioned below the lower end 20t of the resin stack 20A in the first direction D1. In either case, the entry position EP of the rotary blade 70 into the resin stack 20A in the first direction D1 is positioned below the center 20c of the resin stack 20A. Even in these cases, chips are easily directed vertically downward.

In addition, the sealing member 21 stacked on an outermost layer of the stack 100 in the first direction D1 among the plurality of sealing members 21 (that is, the sealing member 21 welded to the current collector 15 of the positive terminal electrode 12 and the negative terminal electrode 13) may be thicker than the other sealing member 21 among the plurality of sealing members 21 (that is, the sealing member 21 welded to the current collector 15 of the bipolar electrode 11) in the first direction D1. In this case, the rigidity of the resin stack 20A is improved, and generation of burrs is more reliably suppressed.

In addition, before step S104, temporary fixing of the sealing member 21 and the spacer 22 is not essential, and step S102 may not be performed. In addition, in step S101, the first electrode body 11A, the second electrode body 12A, and the third electrode body 13A may be separately stacked without being sub-assembled with the spacer 22 and the separator 14.

In addition, in step S104, a high frequency wave may not be applied to the rotary blade 70. In addition, in step S104, when the torque of the rotary blade 70 is sufficient, the torque of the rotary blade 70 may not be adjusted.

Furthermore, in step S105, the sealing member 21 and the spacer 22 may be welded in a direction intersecting the cut surface 20w of the resin stack 20A so that the welded end portion 23 does not reach a region sandwiched by the restraining plates 60.

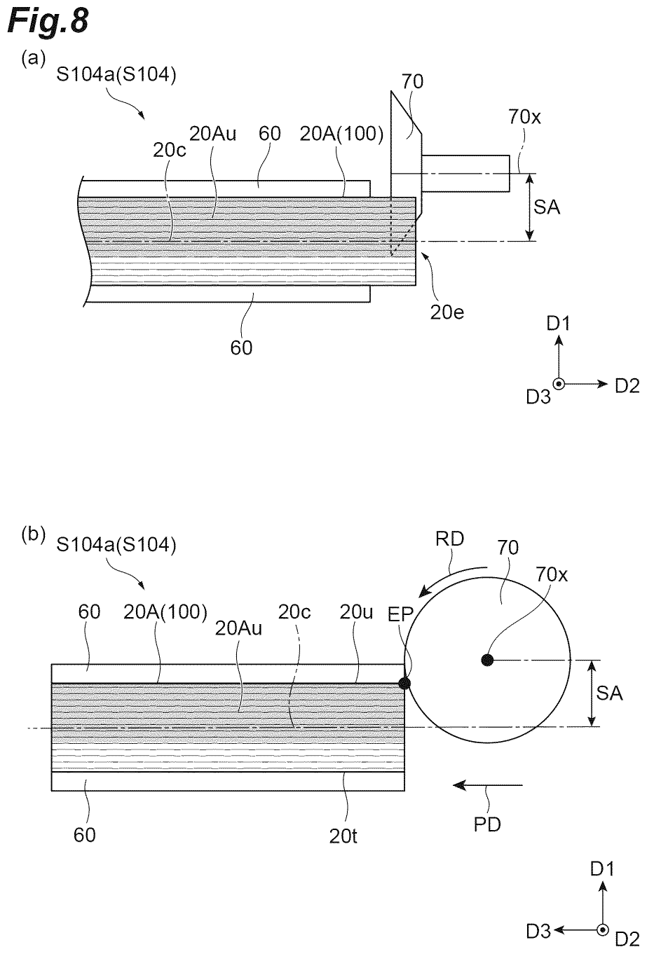

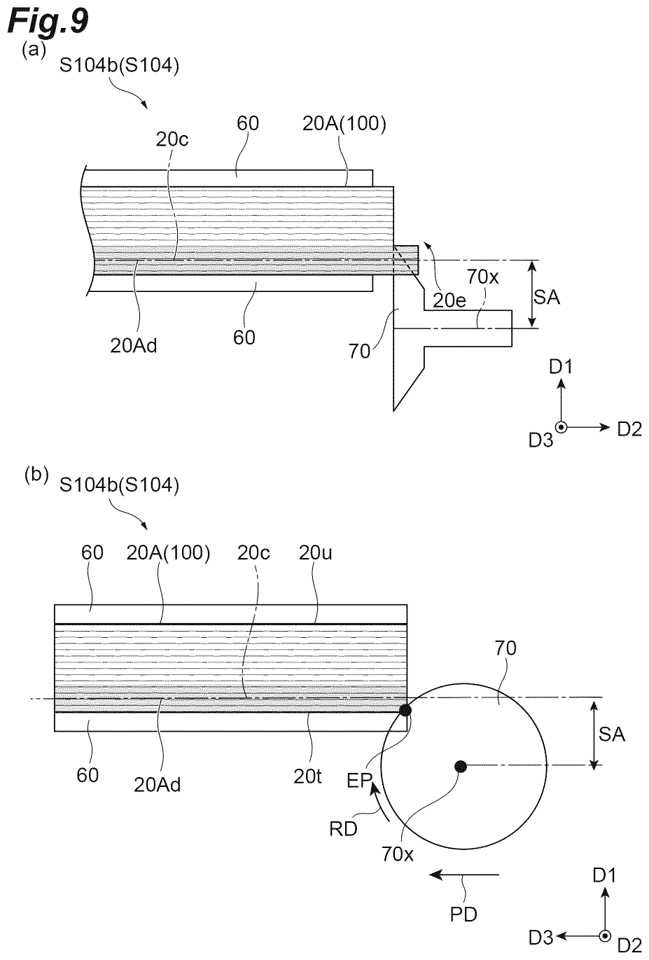

FIGS. 8 and 9 are schematic side views illustrating a method for manufacturing a power storage module according to another modification. As illustrated in FIGS. 8 and 9, step S104 (cutting step) may include step S104a (first cutting step) step S104b (second cutting step). In step S104a, a first portion 20Au (for example, ¾ of the upper portion) on the upper side in the first direction D1 of the resin stack 20A is cut, and in step S104b, a second portion 20Ad (for example, ¼ of the lower portion) on the lower side in the first direction D1 of the resin stack 20A is cut. That is, the resin stack 20A includes the first portion 20Au including an upper end of the resin stack 20A in the first direction D1 and a second portion 20Ad including a lower end of the resin stack 20A in the first direction D1. Then, in step S104, the cutting of the resin stack 20A may be performed through two steps of cutting at the first portion 20Au and cutting at the second portion 20Ad. Each step will be specifically described.

First, in step S104a, as illustrated in FIG. 8, in the first portion 20Au on the upper side in the first direction D1 of the resin stack 20A, the end portion 20e of the outer frame region 20Ab is cut by the rotary blade 70. At this time, the rotary blade 70 is inserted in a direction pressing the opening with respect to the resin stack 20A (that is, downward) so that the opening does not occur in each of the sealing member 21 and the spacer 22 of the resin stack 20A.

That is, in step S104a, the position of the rotation axis 70x of the rotary blade 70 in the first direction D1 is positioned above the center 20c of the resin stack 20A (or the center of the first portion 20Au) in the first direction D1, and the rotation direction RD of the rotary blade 70 with respect to the traveling direction PD of the rotary blade 70 is directed downward. At this time, the entry position EP of the rotary blade 70 into the resin stack 20A in the first direction D1 can be positioned above (for example, at the upper end of) the center 20c of the resin stack 20A. In addition, in the illustrated example, the rotation axis 70x is positioned further above the upper end of the resin stack 20A. As described above, in step S104a, the second portion 20Ad (for example, ¼ of the lower portion) on the lower side in the first direction D1 of the resin stack 20A is cut and left.

Meanwhile, in step S104b, as illustrated in FIG. 9, in the second portion 20Ad on the lower side in the first direction D1 of the resin stack 20A (that is, the portion cut and left in step S104a), the end portion 20e of the outer frame region 20Ab is cut by the rotary blade 70. At this time, the rotary blade 70 is inserted in a direction pressing the opening with respect to the resin stack 20A (that is, upward) so that the opening does not occur in each of the sealing member 21 and the spacer 22 of the resin stack 20A.

That is, in step S104b, the position of the rotation axis 70x of the rotary blade 70 in the first direction D1 is positioned above the center 20c of the second portion 20Ad of the resin stack 20A in the first direction D1, and the rotation direction RD of the rotary blade 70 with respect to the traveling direction PD of the rotary blade 70 is directed upward. At this time, the entry position EP of the rotary blade 70 into the resin stack 20A in the first direction D1 can be positioned below (for example, at the lower end of) the center 20c of the resin stack 20A. In addition, in the illustrated example, the rotation axis 70x is positioned further below the lower end of the resin stack 20A.

Note that the rotation direction RD of the rotary blade 70 with respect to the traveling direction PD being directed upward means that the rotary blade 70 rotates from vertically below to vertically above on the tip side in the traveling direction PD of the rotation axis 70x of the rotary blade 70 as illustrated in the drawing. In addition, the order of step S104a and step S104b is not limited.

As described above, according to the modifications illustrated in FIGS. 8 and 9, the end portion 20e of the resin stack 20A is prevented from escaping as the rotary blade 70 enters, and according to this, the resin stack 20A is prevented from being opened. Therefore, it is possible to suppress the occurrence of an uncut portion caused by the rotary blade 70 failing to hit an escaped and opened portion.

The above embodiment is additionally described as below.

A method for manufacturing a power storage module according to the present disclosure is [1] “A method for manufacturing a power storage module, the power storage module including an electrode stack configured by stacking a plurality of electrodes each including a current collector provided with an active material layer along a first direction, and a sealing body made of a resin, the sealing body provided on the electrode stack so as to surround the electrode stack and sealing an internal space between the current collectors adjacent to each other, the method including: a stacking step of stacking the electrodes and a sealing member made of a resin along the first direction to form a stack including the electrode stack and a resin stack containing a plurality of the sealing members; a restraining step of disposing a pair of restraining plates at both ends of the stack in the first direction and restraining the stack in the first direction by the pair of restraining plates after the stacking step; and a cutting step of cutting a part of the stack by a rotary blade with setting the first direction to an up-down direction in a state where the stack is restrained by the pair of restraining plates to form a cut surface after the restraining step, in which the sealing member is a frame-shaped member provided on a peripheral edge portion of the electrode, the resin stack includes an inner frame region overlapping the electrode stack and an outer frame region protruding from the electrode stack along a second direction intersecting the first direction when viewed in the first direction, in the restraining step, the stack is restrained such that the outer frame region is exposed from the pair of restraining plates while the inner frame region is gripped along the first direction by the pair of restraining plates, and in the cutting step, the cut surface is formed by cutting an end portion of the outer frame region in the second direction while moving the rotary blade along a third direction intersecting the first direction and the second direction”.

The method for manufacturing a power storage module according to the present disclosure may be [2] “The method for manufacturing a power storage module described in [1], in which in the cutting step, a position of a rotation axis of the rotary blade in the first direction is positioned below a center of the resin stack in the first direction, a rotation direction of the rotary blade is directed downward, and an entry position of the rotary blade into the resin stack in the first direction is positioned below the center of the resin stack”.

The method for manufacturing a power storage module according to the present disclosure may be [3] “The method for manufacturing a power storage module described in [1] or [2], including a welding step of welding the resin stack after the cutting step, in which the resin stack includes a plurality of spacers made of a resin stacked along the first direction, in the stacking step, the resin stack is configured so as to surround the electrode stack by stacking the sealing members and the spacers while interposing the spacer having a frame shape between the sealing members, and in the welding step, the plurality of sealing members and the plurality of spacers are welded and integrated with each other on the cut surface in a state where the stack is restrained to form a welded region on the cut surface, and the sealing body is formed from the resin stack”.

The method for manufacturing a power storage module according to the present disclosure may be [4] “The method for manufacturing a power storage module described in any one of [1] to [3], in which in the cutting step, a position of a rotation axis of the rotary blade in the first direction is positioned between a center of the resin stack and a lower end of the resin stack in the first direction”.

The method for manufacturing a power storage module according to the present disclosure may be [5] “The method for manufacturing a power storage module described in [1], in which the resin stack includes: a first portion including an upper end of the resin stack in the first direction, and a second portion including a lower end of the resin stack in the first direction, the cutting step includes: a first cutting step of cutting an end portion of the outer frame region in the first portion by the rotary blade, and a second cutting step of cutting an end portion of the outer frame region in the second portion by the rotary blade, in the first cutting step, a position of a rotation axis of the rotary blade in the first direction is positioned above a center of the resin stack in the first direction and a rotation direction of the rotary blade is directed downward, and in the second cutting step, the position of the rotation axis of the rotary blade in the first direction is positioned below a center of the second portion in the first direction and the rotation direction of the rotary blade is directed upward”.

The method for manufacturing a power storage module according to the present disclosure may be [6] “The method for manufacturing a power storage module described in any one of [1] to [5], in which in the cutting step, a high frequency wave is applied to the rotary blade”.

The method for manufacturing a power storage module according to the present disclosure may be [7] “The method for manufacturing a power storage module described in any one of [1] to [6], in which in the cutting step, a rotation speed of the rotary blade is set to 200 rpm or more and 500 rpm or less”.

The method for manufacturing a power storage module according to the present disclosure may be [8] “The method for manufacturing a power storage module described in [3], in which in the welding step, the sealing member and the spacer are welded in a state where the stack is restrained by the pair of restraining plates”.

The method for manufacturing a power storage module according to the present disclosure may be [9] “The method for manufacturing a power storage module described in [3] or [8], in which in the cutting step, a temporarily welded portion formed by partially welding the sealing member and the spacer is formed on the cut surface”.

The method for manufacturing a power storage module according to the present disclosure may be [10] “The method for manufacturing a power storage module described in any one of [1] to [9], in which in the cutting step, a torque applied to the rotary blade is adjusted such that the torque increases as at least one of the rotation speed of the rotary blade and a traveling speed of the rotary blade decreases”.

The method for manufacturing a power storage module according to the present disclosure may be [11] “The method for manufacturing a power storage module described in [3], including a temporary fixing step of temporarily fixing the sealing member and the spacer by partially welding the sealing member and the spacer on an outer side of the current collector when viewed in the first direction before the cutting step”.

The method for manufacturing a power storage module according to the present disclosure may be [12] “The method for manufacturing a power storage module described in any one of [1] to, in which in the cutting step, the resin stack is cut while applying a point load to the resin stack from above in the outer frame region”.

The method for manufacturing a power storage module according to the present disclosure may be [13] “The method for manufacturing a power storage module described in any one of [1] to, in which the sealing member stacked on an outermost layer of the stack in the first direction among the plurality of sealing members is thicker than the other sealing member among the plurality of sealing members in the first direction”.

### REFERENCE SIGNS LIST

1 power storage module
10 electrode stack
11 bipolar electrode (electrode)
12 positive terminal electrode (electrode)
13 negative terminal electrode (electrode)
15 current collector
20 sealing body
20A resin stack
20Aa inner frame region
20Ab outer frame region
20c center
20t lower end
21 sealing member
22 spacer
60 restraining plate
70 rotary blade
70x rotation axis.

1. A method for manufacturing a power storage module, the power storage module including an electrode stack configured by stacking a plurality of electrodes each including a current collector provided with an active material layer along a first direction, and a sealing body made of a resin, the sealing body provided on the electrode stack so as to surround the electrode stack and sealing an internal space between the current collectors adjacent to each other, the method comprising:
a stacking step of stacking the electrodes and sealing members made of a resin along the first direction to form a stack including the electrode stack and a resin stack containing a plurality of the sealing members;
a restraining step of disposing a pair of restraining plates at both ends of the stack in the first direction and restraining the stack in the first direction by the pair of restraining plates after the stacking step; and
a cutting step of cutting a part of the stack by a rotary blade with setting the first direction to an up-down direction in a state where the stack is restrained by the pair of restraining plates to form a cut surface after the restraining step, wherein
the sealing member is a frame-shaped member provided on a peripheral edge portion of the electrode,
the resin stack includes an inner frame region overlapping the electrode stack and an outer frame region protruding from the electrode stack along a second direction intersecting the first direction when viewed in the first direction,
in the restraining step, the stack is restrained such that the outer frame region is exposed from the pair of restraining plates while the inner frame region is gripped along the first direction by the pair of restraining plates, and
in the cutting step, the cut surface is formed by cutting an end portion of the outer frame region in the second direction while moving the rotary blade along a third direction intersecting the first direction and the second direction.

2. The method for manufacturing a power storage module according to claim 1, wherein
in the cutting step, a position of a rotation axis of the rotary blade in the first direction is positioned below a center of the resin stack in the first direction, a rotation direction of the rotary blade is directed downward, and an entry position of the rotary blade into the resin stack in the first direction is positioned below the center of the resin stack.

3. The method for manufacturing a power storage module according to claim 1, comprising a welding step of welding the resin stack after the cutting step, wherein
the resin stack includes a plurality of spacers made of a resin stacked along the first direction,
in the stacking step, the resin stack is configured so as to surround the electrode stack by stacking the sealing members and the spacers while interposing the spacer having a frame shape between the sealing members, and
in the welding step, the plurality of sealing members and the plurality of spacers are welded and integrated with each other on the cut surface in a state where the stack is restrained to form a welded region on the cut surface, and the sealing body is formed from the resin stack.

4. The method for manufacturing a power storage module according to claim 1, wherein
in the cutting step, a position of a rotation axis of the rotary blade in the first direction is positioned between a center of the resin stack and a lower end of the resin stack in the first direction.

5. The method for manufacturing a power storage module according to claim 1, wherein
the resin stack includes:
a first portion including an upper end of the resin stack in the first direction, and
a second portion including a lower end of the resin stack in the first direction,
the cutting step includes:
a first cutting step of cutting an end portion of the outer frame region in the first portion by the rotary blade, and
a second cutting step of cutting an end portion of the outer frame region in the second portion by the rotary blade,
in the first cutting step, a position of a rotation axis of the rotary blade in the first direction is positioned above a center of the resin stack in the first direction and a rotation direction of the rotary blade is directed downward, and
in the second cutting step, the position of the rotation axis of the rotary blade in the first direction is positioned below a center of the second portion in the first direction and the rotation direction of the rotary blade is directed upward.

6. The method for manufacturing a power storage module according to claim 1, wherein
in the cutting step, a high frequency wave is applied to the rotary blade.

7. The method for manufacturing a power storage module according to claim 1, wherein
in the cutting step, a rotation speed of the rotary blade is set to 200 rpm or more and 500 rpm or less.

8. The method for manufacturing a power storage module according to claim 3, wherein
in the welding step, the sealing member and the spacer are welded in a state where the stack is restrained by the pair of restraining plates.

9. The method for manufacturing a power storage module according to claim 3, wherein
in the cutting step, a temporarily welded portion formed by partially welding the sealing member and the spacer is formed on the cut surface.

10. The method for manufacturing a power storage module according to claim 1, wherein
in the cutting step, a torque applied to the rotary blade is adjusted such that the torque increases as at least one of the rotation speed of the rotary blade and a traveling speed of the rotary blade decreases.

11. The method for manufacturing a power storage module according to claim 3, comprising
a temporary fixing step of temporarily fixing the sealing member and the spacer by partially welding the sealing member and the spacer on an outer side of the current collector when viewed in the first direction before the cutting step.

12. The method for manufacturing a power storage module according to claim 1, wherein
in the cutting step, the resin stack is cut while applying a point load to the resin stack from above in the outer frame region.

13. The method for manufacturing a power storage module according to claim 1, wherein
the sealing member stacked on an outermost layer of the stack in the first direction among the plurality of sealing members is thicker than the other sealing member among the plurality of sealing members in the first direction.
